(19) United States
(12) Patent Application Publication
(10) Pub. No.: US 2017/0272131 A1
(43) Pub. Date: Sep. 21, 2017

(54) Interference Mitigation Systems in High Altitude Platform Overlaid With a Terrestrial Network

(71) Applicant: Google Inc., Mountain View, CA (US)

(72) Inventors: Sharath Ananth, Cupertino, CA (US); Krishna Kamal Sayana, San Jose, CA (US); Mitchell Trott, San Mateo, CA (US)

(73) Assignee: Google Inc., Mountain View, CA (US)

(21) Appl. No.: 15/071,278

(22) Filed: Mar. 16, 2016

(51) Int. Cl. H04B 7/04; H04W 72/04; H04W 72/12; H04B 1/04

(52) U.S. Cl. CPC H04B 7/0408; H04B 1/0475; H04W 72/042; H04W 72/1263

(57) ABSTRACT

A communication system includes an antenna system, data processing hardware in communication with the antenna system, and memory hardware in communication with the data processing hardware and the antenna system. The memory hardware stores instructions that when executed on the data processing hardware cause the data processing hardware to perform operations. These operations include transmitting a first communication signal to a first coverage area and determining an interference to the first communication signal by a second communication signal. The operations further include reducing the interference to the first communication signal by a second communication signal by at least one of: adjusting the first coverage area; or adjusting a power of the first signal.

### TECHNICAL FIELD

This disclosure relates to interference mitigation between high altitude platform networks and terrestrial networks using beam carrier aggregation and beam-forming.

### BACKGROUND

In general, telecommunication is when two or more entities or units exchange information (i.e., communicate) using technology. Channels are used to transmit the information either over a physical medium (e.g., signal cables), or in the form of electromagnetic waves, or a combination of the two. A communication network generally includes transmitters, receivers, and communication channels that transmit the messages from the transmitters to the receivers. Digital communication networks may also include routers that route a message to the correct receiver (e.g., user). Whereas, analog communication networks may also include switches that form a connection between two users. In addition, both the digital and analog communication networks may include repeaters used to amplify or recreate the signal transmitted over long distance. The repeaters are usually used to counteract the attenuation that the signal experiences as it is being transmitted.

### SUMMARY

One aspect of the disclosure provides a communication system that includes an antenna system, data processing hardware in communication with the antenna system, and memory hardware in communication with the data processing hardware and the antenna system. The memory hardware stores instructions that when executed on the data processing hardware cause the data processing hardware to perform operations. These operations include transmitting a first communication signal to a first coverage area and determining an interference to the first communication signal by a second communication signal. The operations further include: reducing the interference to the first communication signal by a second communication signal by at least one of: adjusting the first coverage area; or adjusting a power of the first signal.

Implementations of the disclosure may include one or more of the following optional features. In some implementations, adjusting the first coverage area includes identifying a power source of the second signal, identifying a second coverage area associated with the power source of the second signal, and transmitting the first communication signal to the first coverage area while excluding transmission to the second coverage area. Adjusting the first coverage area may include: identifying a base-station transmitting the second communication signal; identifying a second coverage area receiving a transmission from the base-station; and transmitting the first communication signal to the first coverage area while excluding transmission to the second coverage area. In some examples, adjusting the first coverage area includes identifying a second coverage area using a map stored on the memory hardware and transmitting the first communication signal to the first coverage area while excluding transmission to the second coverage area. The second coverage area may identify a source of the second communication.

In some examples, adjusting the power of the first signal includes: identifying a power of the second signal; identifying a second coverage area associated with the power of the second signal; reducing the power of the first signal, the power of the first signal being less than the power of the second signal; and transmitting the first communication signal having the reduced power to the first and second coverage area. Adjusting the power of the first signal may also include: identifying a base-station transmitting the second communication signal; identifying a second coverage area receiving a transmission from the base-station; reducing the power of the first signal, the power of the first signal being less than the power of the second signal; and transmitting the first communication signal having the reduced power to the first and second coverage area. Adjusting the power of the first signal may further include: identifying a second coverage area using a map stored on the memory hardware, the second coverage area identifying a source of the second communication; reducing the power of the first signal, the power of the first signal being less than the power of the second signal; and transmitting the first communication signal having the reduced power to the first and second coverage area.

Another aspect of the disclosure provides a communication system including data processing hardware and memory hardware in communication with the data processing hardware. The memory hardware stores instructions that when executed on the data processing hardware cause the data processing hardware to perform operations. Those operations include: transmitting a first communication signal within a communication bandwidth to a first coverage area; and determining an interference to the first communication signal by a second communication signal. The interference is within a second coverage area, the first coverage area including the second coverage area. The operations also include: identifying first and second resource portions of the communication bandwidth; identifying the first resource portion as a secondary carrier of the first communication; and identifying the second resource portion as a primary carrier of the first communication. The operations further include transmitting the first communication signal in the second resource portion as the primary carrier in a first transmission mode and transmitting the first communication signal in the first resource portion as the secondary carrier in a second transmission mode. The second transmission mode allows the first communication to reach the first coverage area while reducing the interference to the first communication signal by the second communication signal in the second coverage area.

Implementations of the disclosure may include one or more of the following optional features. In some implementations, the first and second resource portions are frequency portions or time portions. The second coverage area may be within the first coverage area or the second coverage area may be partially within the first coverage area. The first transmission mode may allow the first communication signal to reach the first coverage area and the second coverage area.

In some implementations, the communication system includes an antenna system in communication with the data processing hardware. Transmitting the first communication signal in the first resource portion as the secondary carrier in the second transmission mode may include causing the antenna system to transmit the first communication signal in the first resource portion as the secondary carrier in the second transmission mode to the first coverage area while reducing the interference to the first communication signal by the second communication signal in the second coverage area. The phase array antenna system may include an array of antennas. The operations may further include: identifying the first coverage area; identifying the second coverage area; identifying a transmission region that includes the first coverage area while reducing the interference to the first communication signal by the second communication signal in the second coverage area; and adjusting one or more antennas to transmit a beam configured to reach the transmission region. In some examples, the operations include determining one or more beam-forming weights associated with the beam, by one of: determining a downlink signal transmission of the second communication signal; and determining an uplink transmission of a user device configured to receive the first communication signal, the user device being within the second coverage area.

In some implementations, the antenna system is positioned on one of an aircraft, a communication balloon, or a satellite, and wherein a terrestrial base-station positioned on the earth is transmitting the second communication signal. The antenna system may also include a phased array antenna. The first power associated with the first communication signal in the first resource portion may be greater than a second power associated with the first communication signal in the second resource portion.

In some examples, the operations include executing enhanced inter-cell interference coordination (eICIC) techniques between the first and second communication signals, the eICIC techniques defined by 3GPP release 10. The operations may also include, when transmitting the first communication signal, executing cross-carrier-scheduling for scheduling data packets associated with the first communication signal. Each data packet may include data channels and a control channel, wherein the data channels are configured to be transmitted on the first and second resource portions, and the control channel is configured to be transmitted on only the second resource portion.

In some examples, the operations include, when transmitting the second communication signal, executing cross-carrier-scheduling for scheduling data packets associated with the second communication signal. Each data packet may include data channels and a control channel, wherein the data channels are configured to be transmitted on the first and second resource portions, and the control channel is configured to be transmitted on only the first resource portion. The operations may further include executing enhanced physical downlink control channel (E-PDCCH) techniques between the first and second communication signals, the E-PDCCH techniques defined by 3GPP release 11.

Another aspect of the disclosure provides a method for interference mitigation using carrier aggregation and beam-forming. The method includes: transmitting, from data processing hardware, a first communication signal within a communication bandwidth to a first coverage area; determining, by the data processing hardware, an interference to the first communication signal by a second communication signal, the interference being within a second coverage area, the first coverage area including the second coverage area; and identifying, by the data processing hardware, first and second resource portions of the communication bandwidth. The method also includes: identifying, by the data processing hardware, the first resource portion as a secondary carrier of the first communication; identifying, by the data processing hardware, the second resource portion as a primary carrier of the first communication; and transmitting, by the data processing hardware, the first communication signal in the second resource portion as the primary carrier in a first transmission mode. The method further includes transmitting, from the data processing hardware, the first communication signal in the first resource portion as the secondary carrier in a second transmission mode. The second transmission mode allows the first communication to reach the first coverage area while reducing the interference to the first communication signal by the second communication signal in the second coverage area.

This aspect may include one or more of the following optional features. The first and second resource portions may be frequency portions or time portions. The second coverage area may be within the first coverage area or the second coverage area may be partially within the first coverage area. The first transmission mode may allow the first communication signal to reach the first coverage area and the second coverage area. The method may also include causing a phased array antenna system in communication with the data processing hardware, to transmit the first communication signal in the first resource portion as the secondary carrier in the second transmission mode to the first coverage area while reducing the interference to the first communication signal by the second communication signal in the second coverage area.

In some examples, the method includes: identifying, by the data processing hardware, the first coverage area; identifying, by the data processing hardware, the second coverage area; identifying, by the data processing hardware, a transmission region that includes the first coverage area while reducing the interference to the first communication signal by the second communication signal in the second coverage area; and adjusting one or more antennas of an array of antennas of the phased array antenna system to transmit a beam configured to reach the transmission region. The method may also include determining, by the data processing hardware, one or more beam-forming weights associated with the beam, by one of: determining a downlink signal transmission of the second communication signal; and determining an uplink transmission of a user device configured to receive the first communication signal, where the user device is within the second coverage area.

The phased array antenna system may be positioned on one of an aircraft, a communication balloon, or a satellite. A terrestrial base-station positioned on the earth may be transmitting the second communication signal. A first power associated with the first communication signal in the first resource portion may be greater than a second power associated with the first communication signal in the second resource portion.

In some implementations, the method includes executing, by the data processing hardware, enhanced inter-cell interference coordination (eICIC) techniques between the first and second communication signals. The eICIC techniques are defined by 3GPP release 10. In some examples, the method includes, when transmitting the first communication signal, executing, by the data processing hardware, cross-carrier-scheduling for scheduling data packets associated with the first communication signal. Each data packet may include data channels and a control channel, wherein the data channels are configured to be transmitted on the first and second resource portions, and the control channel may be configured to be transmitted on only the second resource portion. The method may further include, when transmitting the first communication signal, executing, by the data processing hardware, cross-carrier-scheduling for scheduling data packets associated with the first communication signal. Each data packet may include data channels and a control channel, wherein the data channels are configured to be transmitted on the first and second resource portions, and the control channel is configured to be transmitted on only the second resource portion. The method may also include, when transmitting the second communication signal, executing, by the data processing hardware, cross-carrier-scheduling for scheduling data packets associated with the second communication signal. Each data packet may include data channels and a control channel, wherein the data channels are configured to be transmitted on the first and second resource portions, and the control channel is configured to be transmitted on only the first resource portion. In some examples, the method includes executing, by the data processing hardware, enhanced physical downlink control channel (E-PDCCH) techniques between the first and second communication signals, the E-PDCCH techniques defined by 3GPP release 11.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B area schematic views of an exemplary communication system.

FIG. 2 is a perspective view of example user equipment.

FIGS. 3A-3C are perspective views of example high altitude platforms.

FIG. 4A is a schematic view of an example aggregation of contiguous carriers within the same operating frequency band.

FIG. 4B is a schematic view of an example aggregation of non-contiguous carriers within the same operating frequency band.

FIG. 4C is a schematic view of an example aggregation of non-contiguous carriers within different operating frequency band.

FIGS. 5A and 5B are schematic views of a frequency resource band being shared between the terrestrial network and the non-terrestrial network.

FIGS. 5C and 5D are schematic views of a time resource band being shared between the terrestrial network and the non-terrestrial network.

FIG. 6 is an example arrangement of operations for transmitting a communication.

FIG. 7 is a schematic view of an example computing device executing any systems or methods described herein.

Like reference symbols in the various drawings indicate like elements.

### DETAILED DESCRIPTION

Long-Term Evolution (LTE) is a standard for wireless communication of high-speed data for mobile phones and data terminals. LTE is based on the Global System for Mobile Communications/Enhanced Data Rates for GSM Evolution (GSM/EDGE) and Universal Mobile Telecommunication System/High Speed Packet Access (UMTS/HSPA) network technologies. LTE is configured to increase the capacity and speed of the telecommunication by using different ratio interfaces in addition to core network improvements. LTE supports scalable carrier bandwidths, from 1.4 MHz to 20 MHz and supports both frequency division duplexing (FDD) and time-division duplexing (TDD). Generally, LTE networks are terrestrial networks, which means that base-stations associated with the network are positioned on earth. Terrestrial networks are different from non-terrestrial networks where the base-stations associated with the network are not positioned on the earth. For example, some base-stations may be positioned on high altitude platforms, such as, but not limited to, communication balloons, aircrafts, and satellites. It is desirable to design a network that supports LTE and includes both terrestrial and non-terrestrial networks, therefore providing the users a better network experience, a larger coverage area, and better network experience, among other benefits.

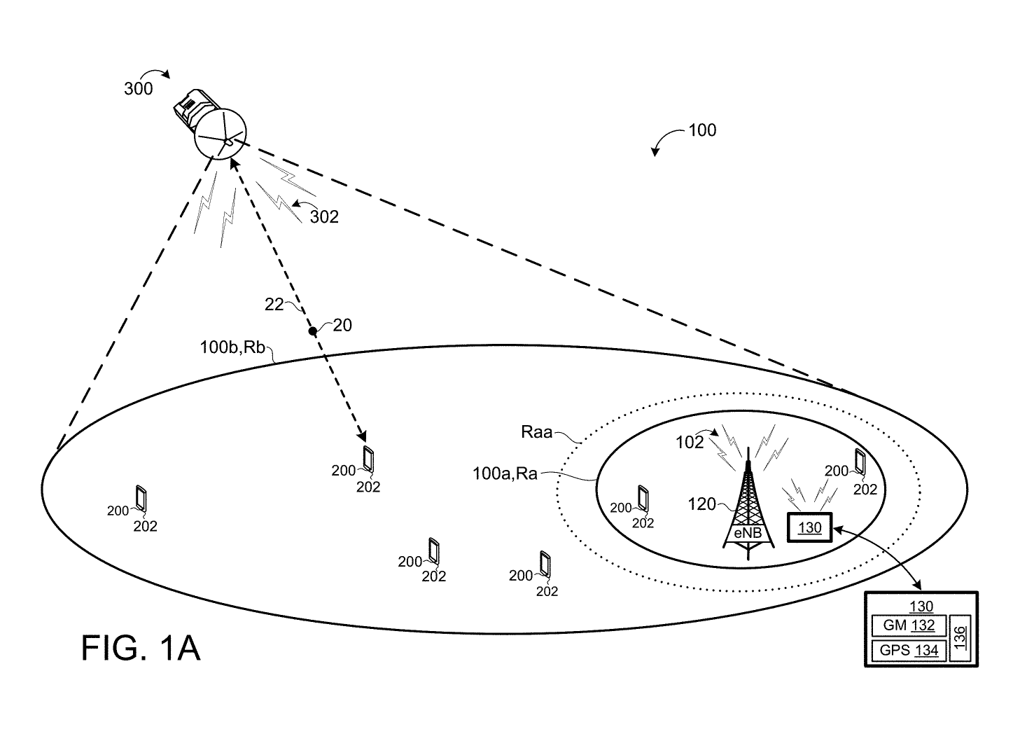

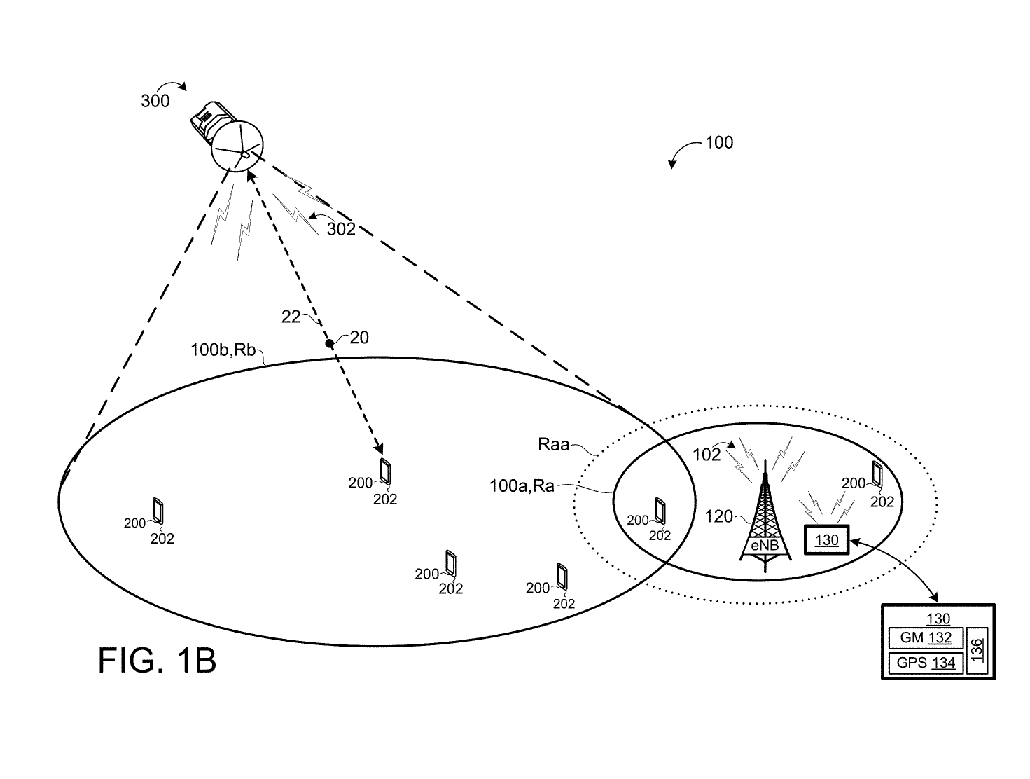

Referring to FIGS. 1A-2, in some implementations, a hybrid network 100 includes terrestrial network(s) 100a and non-terrestrial network(s) 100b. In some implementations, the non-terrestrial network 100b includes the terrestrial network 100a as shown in FIG. 1A, while in other implementations, the non-terrestrial network 100b overlaps with a portion of the terrestrial network 100a as shown in FIG. 1B. The terrestrial network 100a may include one or more of macrocell, femtocell, picocell, and microcell, each defining a coverage range of the network. The terrestrial network 100a includes multiple terrestrial base-stations 120. In some examples, the terrestrial base-stations 120 are Evolved node Bs (also referred to as eNode B or eNB). An eNB 120 is a logic network element, which can be embodied as a single piece of hardware, but it can also be implemented in distributed ways. An eNB 120 connects to the mobile terrestrial network 100a and communicates directly with one or more User Equipment (UE) 200. The eNB 120 uses two E-UTRA protocols, the Orthogonal Frequency-Division Multiple Access (OFDMA) for downlink and the Single-carrier FDMA (SC-FDMA) for uplink. The eNB 120 uses multiple protocols when interfacing with different elements. For example, the eNB 120 includes X2-interface using X2-AP protocol when communicating with other eNBs 120.

Referring to FIG. 2, each UE 200 is a logic network element that may be embedded in a user device 202. The user device 202 is capable of transmitting and/or receiving voice/data over the network 100. User devices 202 may include, but are not limited to, mobile computing devices, such as laptops 202a, tablets 202b, smart phones 202c, wearable computing devices 202d (e.g., headsets and/or watches), smart books, netbooks, cordless phones, wireless local loop (WLL) stations, and Bluetooth devices. User devices 200 may also include other computing devices having other form factors, such as computing devices included in desktop computers 202e, vehicles, gaming devices, televisions, or other appliances (e.g., networked home automation devices and home appliances). The UEs 200 are configured to support one or more wireless technologies, such as, but not limited to, Long Term Evolution (LTE), Wideband Code Division Multiple Access (WCDMA), CDMA IX, Evolution-Data Optimized (EVDO), Time Division Synchronous Code Division Multiple Access (TD-SCDMA), Global System for Mobile Communications (GSM), IEEE 802.11.

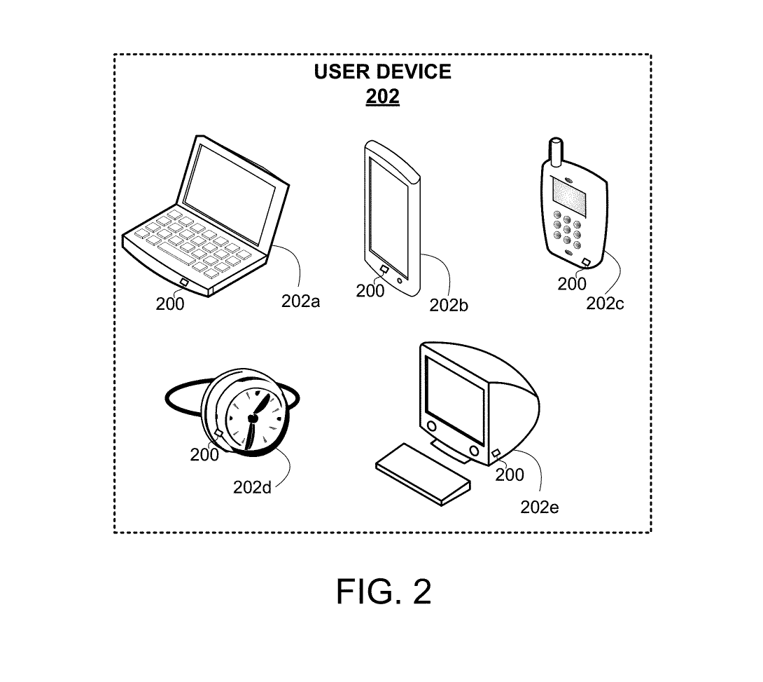

Referring back to FIGS. 1A and 1B, the non-terrestrial network 100b may include one or more high altitude platforms (HAPs) 300, such as, but not limited to, an aircraft 300a (FIG. 3A), a communication balloon 300b (FIG. 3B), or a satellite 300c (FIG. 3C). Referring to FIGS. 3A and 3B, in some implementations, the HAP 300 is an aircraft 300a or a communication balloon 300b and includes an antenna system 310 that receives/transmits a communication 20 from a UE 200. The antenna system 310 may be any type of antenna configured for use with the HAP 300. The antenna system 310 may include, but not limited to, adaptive antenna arrays, phased arrays, or switched beam systems. Other antenna types may be possible as well. The example below discusses the antenna system 310 as being a phased array antenna that includes a wideband active phased array antenna 312 and an antenna data processing hardware 314. Other antennas, besides the phased array antenna, may be used as well. In some examples, the antenna data processing hardware 314 is part of the HAP data processing hardware 320, 320a, 320b. The phased array antenna systems 310 provide fast beam steering, which is the ability to generate simultaneous beams and dynamically adjust the characteristics of the beam patterns. The phased array antenna 312, 312a, 312b includes a set of individual antennas that transmit and/or receive radio waves. The individual antennas are connected together in such a way that the individual current of each antenna has a specific amplitude and phase relationship, allowing the individual antennas to act as a single antenna. The relative phases of the respective signals feeding the antennas of the phased array antenna are set in a manner that an effective radiation pattern of the array is reinforced in a desired direction and suppressed in undesired directions. The phase relationships between the individual antennas may be fixed (e.g., a tower array antenna), or adjustable (e.g., beam steering antenna). In some examples, the phased array antenna 312, 312a, 312b includes antennas disposed on a micro strip and a phase shifter connected to at least one of the antennas. Moreover, the wideband active phased array antenna 312, 312a, 312b allows the transmission of the message bandwidth, which significantly exceeds the coherence bandwidth of the channel. In some examples, active phased array antennas 312, 312a, 312b incorporate transmit amplification with phase shift in each antenna element or group of elements.

The antenna data processing hardware 314, 314a, 314b of the phased array antenna system 310 may include the tracking device 316, 316a, 316b or may be in communication with the tracking device 316, 316a, 316b. The data processing hardware 314, 314a, 314b of the phased array antenna system 310 is configured to identify a target coverage area (e.g., the non-terrestrial network 100b) for allowing communication 20 to be transmitted/received between the phased array antenna system 310 and UEs 200 (e.g., UEs 200 having a line-of-sight with the phased array antenna 312) and establish a communication connection or link 22 between the target HAP 300 and the UE(s) 200. A more detailed description of the antenna system 310 is provided in U.S. patent application Ser. No. 14/809,588, filed Jul. 27, 2015 and U.S. patent application Ser. No. 14/810,761, filed Jul. 28, 2015. The disclosures of these applications are considered part of the disclosure of this application and are hereby incorporated by reference in their entireties.

In some examples, the HAP 300 includes a data processing device 320 that processes the received communication 20 and determines a path of the communication 20 to arrive at a destination UE 200. The data processing device 320 may include a modem 322 that processes the received communication before transmitting it to a destination (i.e., between two UEs 200).

FIG. 3A illustrates an example aircraft 300a, such as an unmanned aerial vehicle (UAV). A UAV, also known as a drone, is an aircraft without a human pilot onboard. There are two types of UAVs, autonomous aircrafts and remotely piloted aircraft. As the name suggests, autonomous aircrafts are designed to autonomously fly, while remotely piloted aircrafts are in communication with a pilot who pilots the aircraft. In some examples, the aircraft 300a is remotely piloted and autonomous at the same time. The UAV usually includes wings to maintain stability, a Global Positioning System (GPS) to guide it through its autonomous piloting, and a power source (e.g., internal combustion engine or electric battery) to maintain long hours of flight. In some examples, the UAV is designed to maximize efficiency and reduce drag during flight. Other UAV designs may be used as well.

FIG. 3B illustrates an example communication balloon 300b that includes a balloon 330 (e.g., sized about 49 feet in width and 39 feet in height and filled with helium or hydrogen), an equipment box 332, and solar panels 334. The equipment box 332 includes a location data processing device 336 that executes algorithms to determine where the communication balloon 300b needs to go. Each communication balloon 300b moves into a layer of wind blowing in a direction that may take it where it should be going. The equipment box 332 also includes batteries to store power and a transceiver (e.g., in communication with an antenna (not shown)) to communicate with other HAPs 300. The solar panels 334 may power the equipment box 332. In some examples, the equipment box 332 includes the data processing device 320, which includes the modem 322.

Communication balloons 300b are typically released in to the earth's stratosphere to attain an altitude between 11 to 23 miles and provide connectivity for a ground area of 25 miles in diameter at speeds comparable to terrestrial wireless data services (such as, 3G or 4G). The communication balloons 300b float in the stratosphere, at an altitude twice as high as airplanes and the weather (e.g., 20 km above the earth's surface). The communication balloons 300b are carried around the earth by winds and can be steered by rising or descending to an altitude with winds moving in the desired direction. Winds in the stratosphere are usually steady and move slowly at about 5 and 20 mph, and each layer of wind varies in direction and magnitude.

Referring to FIG. 3C, a satellite 300c is an object placed into orbit around the earth and may serve different purposes, such as military or civilian observation satellites, communication satellites, navigation satellites, weather satellites, and research satellites. The orbit of the satellite 300c varies depending in part on the purpose of the satellite 300c. Satellite orbits may be classified based on their altitude from the surface of the earth as Low Earth Orbit (LEO), Medium Earth Orbit (MEO), and High Earth Orbit (HEO). LEO is a geocentric orbit (i.e., orbiting around the earth) that ranges in altitude from 0 to 1,240 miles. MEO is also a geocentric orbit that ranges in altitude from 1,200 mile to 22,236 miles. HEO is also a geocentric orbit and has an altitude above 22,236 miles. Geosynchronous Earth Orbit (GEO) is a special case of HEO. Geostationary Earth Orbit (GSO, although sometimes also called GEO) is a special case of Geosynchronous Earth Orbit. Satellites 300c placed in the GEO orbit can “stand still” with respect to a certain location on earth. Thus, a person on earth looking at a satellite 300c in the GEO orbit would perceive that the satellite 300c is not moving. Therefore, the satellites 300c in GEO orbit maintain a position with respect to a location on earth.

In some implementations, a satellite 300c includes a satellite body 340 having a payload that includes a data processing device 320, 320c, e.g., similar to the data processing device 320 of the aircraft 300a and the communication balloon 300b. The data processing device 320c executes algorithms to determine where the satellite 300c is heading. The satellite 300c also includes an antenna 310, 310c for receiving and transmitting a communication 20. The satellite 300c includes solar panels 350 mounted on the satellite body 340 for providing power to the satellite 300c. In some examples, the satellite 300c includes rechargeable batteries used when sunlight is not reaching and charging the solar panels 350.

In some examples, the payload of each satellite 300c includes one or more transponder(s) 352. Each transponder 352 receives a signal or communication 20 from an UE 200, and processes, encodes, amplifies, and rebroadcasts the communication 20 over a large area of the surface of the earth to one or more UEs 200. Each transponder 352 handles a particular frequency range (i.e., bandwidth or channels) centered on a specific frequency. In some examples, each satellite 300c includes at least one transponder 352, each transponder 352 capable of supporting one or more communication channels.

In some implementations, the satellite 300c includes tracking, telemetry, command and ranging (TT&R) that provides a connection between the satellite 300c and facilities on the ground, e.g., the UEs 200. The TT&R ensures that the satellite 300c establishes communication or a link 22 to successfully receive/transmit a communication 20. The TT&R performs several operations, including, but not limited to, monitoring the health and status of the satellite 300c by way of collecting, processing, and transmitting data from the one source (e.g., a first UE 200) to the destination (e.g., a second UE 200) or vice versa. Another operation includes determining the satellite's exact location by way of receiving, processing, and transmitting of communications 20. Yet another operation of the TT&R includes properly controlling the satellite 300c through the receiving, processing, and implementing of commands transmitted from the UEs 200. In some examples, a ground operator controls the satellite 300c; however, such an intervention by the operator is only minimal or in case of an emergency and the satellite 300c is mostly autonomous.

In some examples, the satellite 300c includes batteries to operate the satellite 300c when the solar panels 350 of the satellite 300c are hidden from the sun due to the earth, the moon, or any other objects. In some examples, the satellite 300c also includes a reaction control system (RCS) that uses thrusters to adjust the altitude and translation of the satellite 300c, making sure that the satellite 300c stays in its orbit. The RCS may provide small amounts of thrusts in one or more directions and torque to allow control of the rotation of the satellite 300c (i.e., roll, pitch, and yaw).

Referring again to FIGS. 1A and 1B, in some implementations, the network 100a includes a controller 130 (e.g., data processing hardware). The controller 130 may include a grandmaster clock (GM) 132 and a GPS 134. The GM 132 provides the root timing of the hybrid network 100, by transmitting synchronized information to the clocks located at the eNBs 120. In this case, the GM 132 provides the master clock, while the eNBs 120 are slaves. The GM 132 communicates with the GPS 134 that provides the time to the GM 132. In some examples, the controller 130 is part of the eNB 120, the UEs 200, or the HAP 300; while in other examples, the controller 130 is a standalone device (as shown). In some examples, the controller 130 includes or is in communication with memory hardware 136. The memory hardware 136 stores instructions that when executed on the controller 130 cause the controller 130 to perform specific operations.

With continued reference to FIGS. 1A and 1B, in some implementations, the non-terrestrial network 100b is deployed in areas where the terrestrial network 100a already exists (FIG. 1A) or in portions of areas where the terrestrial network 100a already exists (FIG. 1B), which results in a brownfield deployment. A brownfield development describes problem spaces that need the development and deployment of new software systems in the immediate presence of existing or legacy software applications/systems. Therefore, the new software architecture, i.e., the non-terrestrial network 100b, considers and coexists with the existing or legacy software architecture, i.e., the terrestrial network 100a or portions of the non-terrestrial network 100b that overlap with the terrestrial network 100a. Thus, introduction of the non-terrestrial signal 302 (e.g., LTE signals) to the network 100 causes interference with the terrestrial signals 102 as well as other non-terrestrial signals 302. In other words, the non-terrestrial signals 302 and terrestrial signals 102 do not interfere in areas outside the extended coverage area Raa and inside the non-terrestrial coverage area Rb. However, interference between the non-terrestrial signals 302 and terrestrial signals 102 does occur in the extended coverage area Raa and sometimes in the terrestrial coverage areas Ra. Therefore, it is desirable to consider ways or methods to limit or reduce the impact of the interference within the extended coverage area Raa and the terrestrial coverage areas Ra.

In some implementations, reducing the interference of the non-terrestrial signals 302 with the terrestrial signal 102 of the terrestrial coverage area Ra, Raa may be implemented in one of three ways or a combination thereof. For example, a protected control channels method, a beam forming method, or a power control method may be used separately or in combination to reduce the interference between the non-terrestrial signals 302 and the terrestrial signals 102, when the non-terrestrial signals 302 are deployed in an area already having terrestrial coverage.

Protected Control Method

In some implementations, reducing the interference of the non-terrestrial signal 302 with the terrestrial signal 102 may be implemented by protecting a control channel associated with a resource (time or frequency). Protecting the control channel associated with the resource may be implemented using one of: carrier aggregation, E-PDCCH (enhanced Dedicated Physical Control Channel), or eICIC (enhanced inter-Cell Interference Coordination). In some examples, a combination of the three methods may be used.

Carrier Aggregation

Carrier aggregation or channel aggregation (CA) may be used to overcome the interference caused by the terrestrial network 100a and the non-terrestrial network 100b. UEs 200 located in a coverage area of multiple carriers may achieve wider bandwidth and higher data rates by using multiple carriers simultaneously. CA increases the bandwidth of the communication link 22 and thereby increases the bitrate, and is mainly used in LTE systems. CA may be used for both Frequency-Division Duplexing (FDD) and Time-Division Duplexing (TDD), i.e., for both time and frequency resources. FDD means that the transmitting device and the receiving device operate at different carrier frequencies; while TDD means that time-division multiplexing is applied to separate transmit and receive signals using the same carrier frequency. A carrier signal is a transmitted electromagnetic pulse or wave at a steady base frequency of alternation on which information is imposed by increasing signal strength, varying the wave phase, or other means, i.e., modulation.

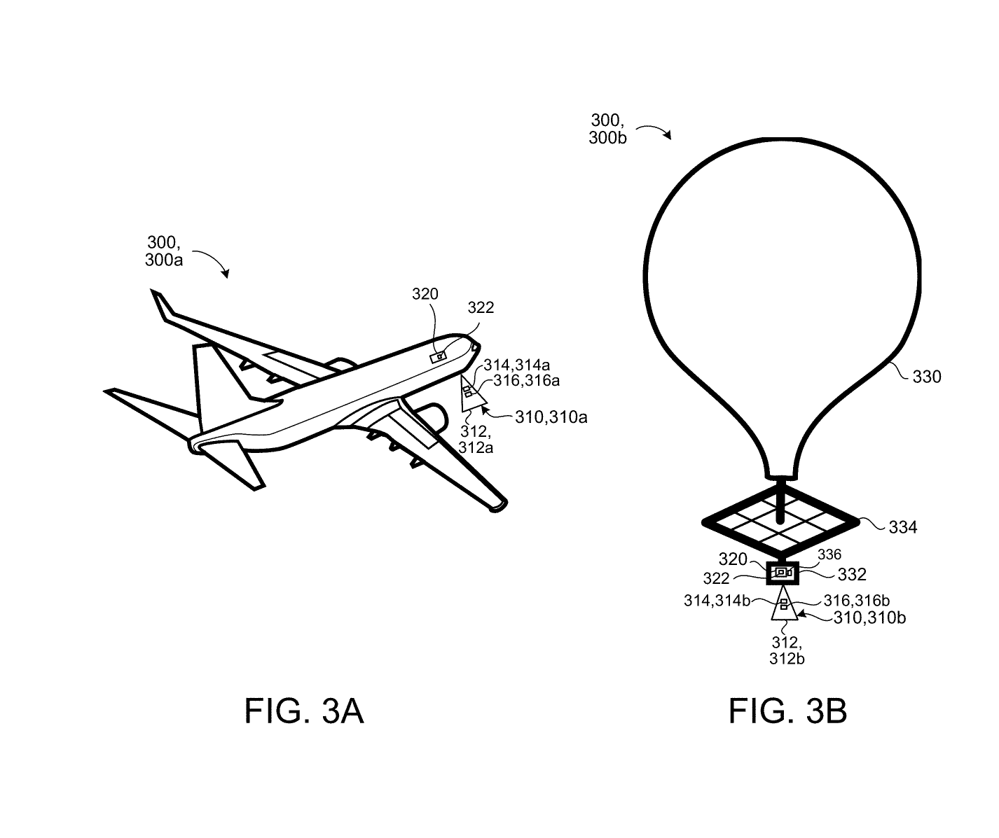

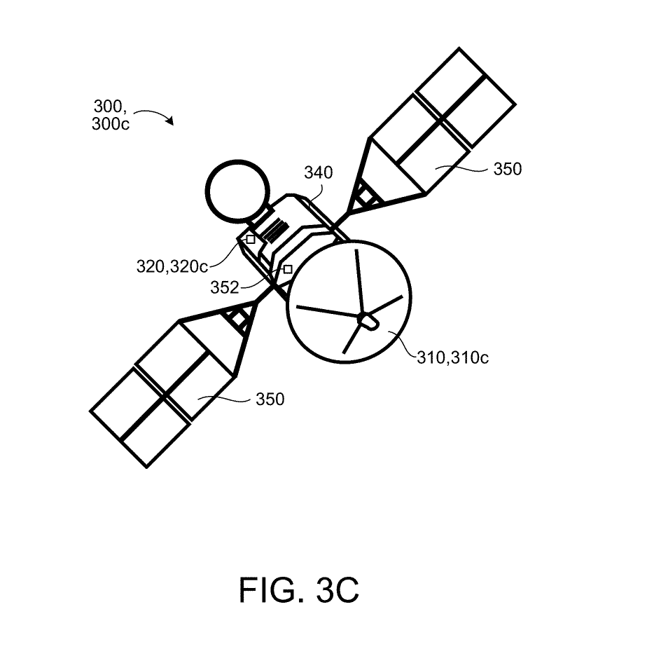

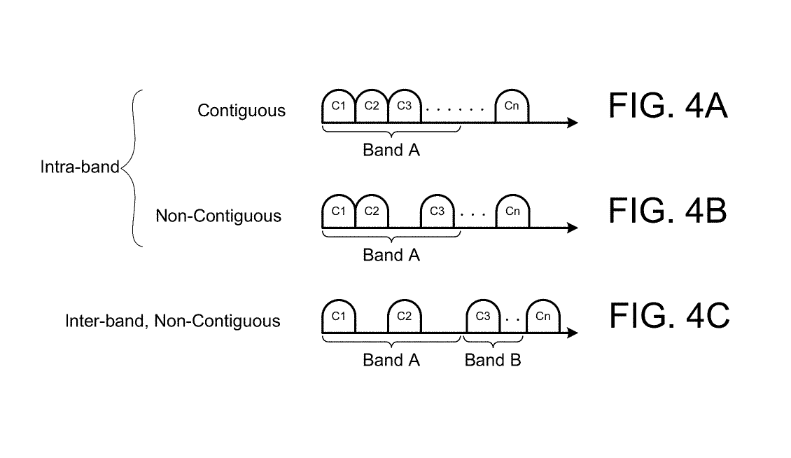

Referring to FIGS. 4A-4C, CA allows for the use of more than one carrier C1-Cn, which increases the overall transmission bandwidth. The aggregated channels or carriers C1-Cn may be contiguous elements (FIG. 4A) or non-contiguous elements (FIG. 4B) of the spectrum, or they may be in different bands (FIG. 4C). CA may be intra-band (FIGS. 4A and 4B) or inter-band (FIG. 4C). In some examples, each carrier C1-Cn has a bandwidth of 1.4, 3, 5, 10, 15, or 20 MHz and each bandwidth has a maximum of five carriers C1-Cn that may be aggregated, resulting in a maximum aggregated bandwidth of 100 MHz. In FDD, the number of aggregated carriers in the uplink may be different than the number of aggregated carriers in the downlink. In some examples, each carrier C1-Cn is of a different bandwidth. FIG. 4A illustrates the aggregation of contiguous carriers C1, C2, C3, within the same operating frequency band, i.e., intra-band contiguous. FIG. 4B illustrates the aggregation of non-contiguous carriers C1, C2, C3 within the same operating frequency band, i.e., intra-band non-contiguous. In this case, the carriers C1, C2, C3 may not be contiguous because there is a gap between them; as shown, there is a gap between carrier C2 and carrier C3. FIG. 4C illustrates an instance where the aggregated carriers C1, C2, C3, belong to different frequency bands, Band A and Band B.

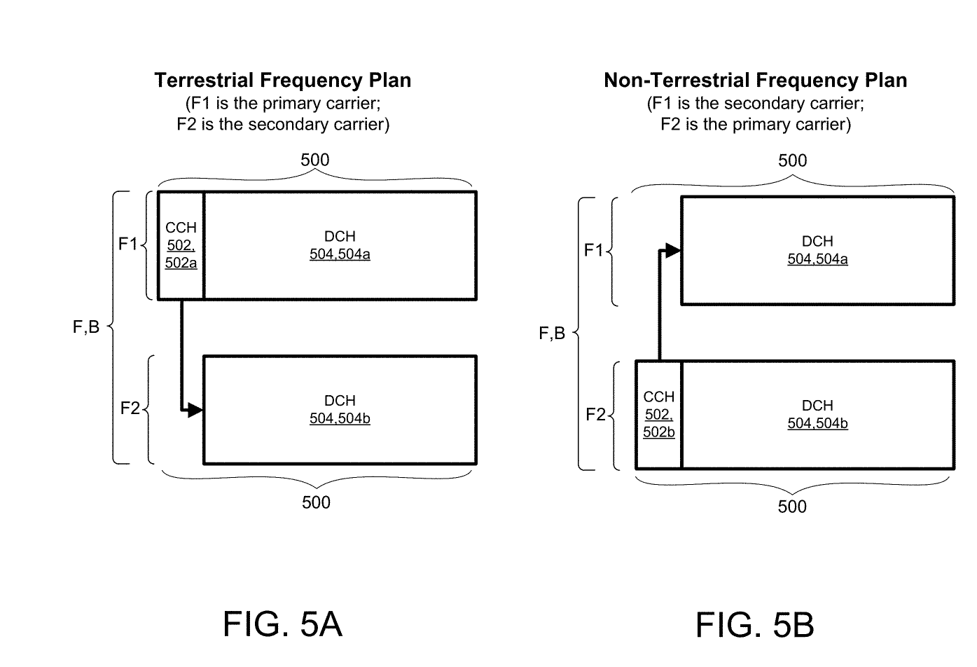

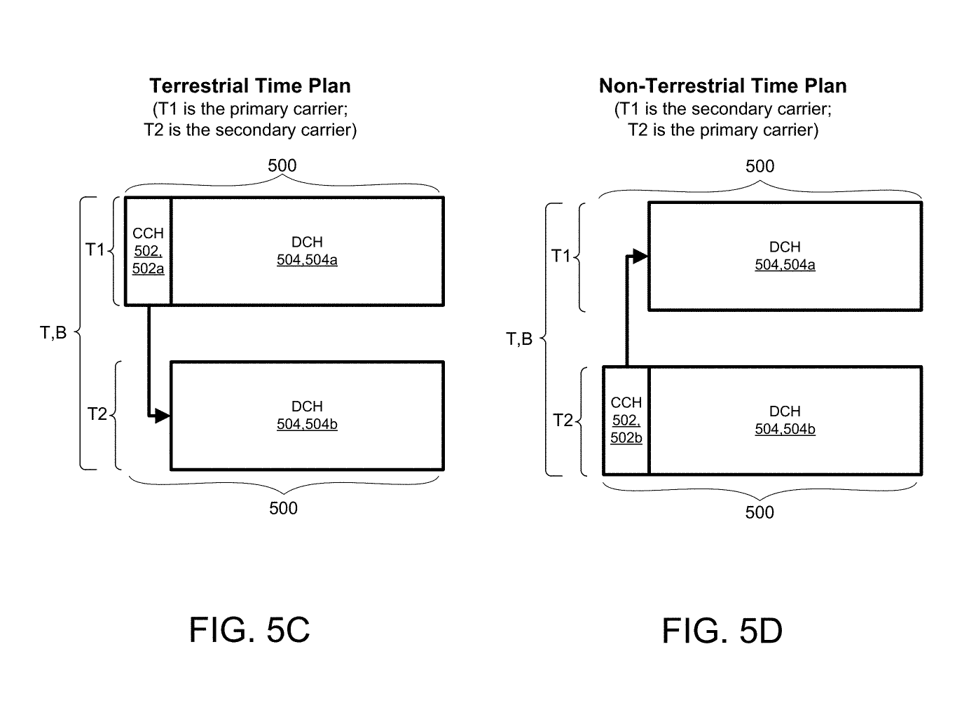

Referring to FIGS. 5A and 5B, in some implementations, when the non-terrestrial network 100b is deployed, the bandwidth used by either network 100a, 100b may overlap, resulting in interference amongst the communication signals 102, 302. To avoid such interference, each network 100a, 100b shares a portion of its overlapping bandwidth referred to as a resource with the other network 100a, 100b. A resource may be a time resource or a frequency resource. For example, as shown in FIG. 5A, the terrestrial network 100a shares a portion of its bandwidth (using a frequency F resource), which is the interfering bandwidth, with the non-terrestrial network 100b. As shown, the terrestrial network 100a uses a first portion F1 of the frequency F and the non-terrestrial network 100b uses a second portion F2 of the frequency F. The first and second frequency portions F1, F2 transmit frames 500. Generally, each frame 500 includes a control channel (CCH) 502 and a data channel (DCH) 504. The use of cross-carrier-scheduling (CCS) allows one of the networks 100a, 100b to schedule data packets (e.g., the communication 20) over the entire bandwidth, i.e., frequency F (F1 and F2), however the CCH 502 is limited to the one network 100a, 100b. For example, referring to FIG. 5A, using CCS in the terrestrial network 100a allows the terrestrial network 100a (e.g., the controller 130) to schedule data packets over the entire bandwidth (F1 and F2); however, the CCH 502a is limited to only the first frequency portion F1 associated with the terrestrial network 100a, and the DCH 504b of the second frequency portion F2 is scheduled by the CCH 502a of the first frequency portion F1. Similarly, referring to FIG. 5B, using CCS in the non-terrestrial network 100b allows the non-terrestrial network 100b (e.g., the controller 130) to schedule data packets over the entire bandwidth (F1 and F2); however, the CCH 502b is limited to only the second frequency portion F2 associated with the non-terrestrial network 100b, and the DCH 504a of the first frequency portion F1 is scheduled by the CCH 502b of the second frequency portion F2. As described in FIGS. 5A and 5B, both the terrestrial and non-terrestrial networks 100a, 100b support 3GPP Release-10 type CA with CCS. As described, the CCH 502 is immunized from interference. Similarly, FIGS. 5C and 5D show the terrestrial network 100a sharing a portion of its bandwidth (using a time T resource), which is the interfering bandwidth, with the non-terrestrial network 100b. As shown, the terrestrial network 100a uses a first portion T1 of the Time T resource and the non-terrestrial network 100b uses a second portion T2 of the Time T resource. The first and second time portions T1, T2 transmit frames 500. Generally, each frame 500 includes a control channel (CCH) 502 and a data channel (DCH) 504. The use of cross-carrier-scheduling (CCS) allows one of the networks 100a, 100b to schedule data packets (e.g., the communication 20) over the entire bandwidth, i.e., Time T resource (T1 and T2), however the CCH 502 is limited to the one network 100a, 100b. For example, referring to FIG. 5C, using CCS in the terrestrial network 100a allows the terrestrial network 100a (e.g., the controller 130) to schedule data packets over the entire bandwidth (T1 and T2); however, the CCH 502a is limited to only the first time portion T1 associated with the terrestrial network 100a, and the DCH 504b of the second time portion T2 is scheduled by the CCH 502a of the first time portion T1. Similarly, referring to FIG. 5B, using CCS in the non-terrestrial network 100b allows the non-terrestrial network 100b (e.g., the controller 130) to schedule data packets over the entire bandwidth (T1 and T2); however, the CCH 502b is limited to only the second time portion T2 associated with the non-terrestrial network 100b, and the DCH 504a of the first time portion T1 is scheduled by the CCH 502b of the second time portion T2. As shown in FIGS. 5C and 5D, both the terrestrial and non-terrestrial networks 100a, 100b support 3GPP Release-10 type CA with CCS. As described, the CCH 502 is immunized from interference. Therefore, the deployment of the non-terrestrial network 100b does not degrade or interfere with the performance of the control channel 502, resulting in a more robust performance as compared to deploying HAP signals without CA as descried above.

Referring back to FIGS. 1A and 1B, the terrestrial network 100a is limited to a coverage area Ra, due to the distance of the transmitting antenna (e.g., the terrestrial base-station 120 or the HAP 300) from the earth. In addition, the signals 102 of the terrestrial network 100a fail to reach the region outside the terrestrial coverage area Ra (or an expansion region Raa). Therefore, any UE 200 outside the terrestrial region Ra (or an expansion region Raa) receives non-terrestrial signals 302 that are not interfered by the terrestrial signals 102. In some examples, cell range expansion (CRE) is used to expand the coverage area Raa of the terrestrial network 100a. CRE allows a UE 200 to be served by a terrestrial network 100a that has a weaker received power from the terrestrial network 100a than the non-terrestrial network 100b, by adding a positive bias to the communication signal quality received in that region Raa. Therefore, UEs 200 within the expanded coverage area Raa are biased to use the terrestrial network 100a. Any UE 200 outside the expanded coverage area Raa sees signals 302 from the non-terrestrial network 100b and is not interfered by the terrestrial network 100a.

In some examples, the non-terrestrial network 100b does not implement CA and transmits communications 20 on the second portion of the resource F2, T2, and therefore does not transmit on the first portion of the resource F1, T1. However, the terrestrial network 100 implements CA and uses the entire bandwidth, i.e., both resources F1, T1 and F2, T2. In this case, a UE 200 in communication with the non-terrestrial network 100b, i.e., the UE 200 is outside the extended coverage area Raa (which is also outside the terrestrial coverage area Ra), receives/transmits signals 302 from the HAP 300 associated with the non-terrestrial network 100b, and utilizes only the second portion of the resource F2, T2 allocated to non-terrestrial transmissions. For UEs 200 that are close to the base-station 120 associated with the terrestrial network 100a, for example, within the terrestrial coverage area Ra, the terrestrial signal 102 is much stronger than the non-terrestrial signal 302 from the HAP 300 associated with the non-terrestrial network 100b. In this instance, UEs 200 close to the terrestrial base-station 120 are able to use the entire bandwidth (F1+F2 or T1+T2) and experience no loss. The signal 302 from the HAP 300 is weak compared to the signal 102 of the terrestrial base-station 120 due to power limitation and the distance of the HAP 300 from the earth. In some examples, the UEs 200 are not very close to the terrestrial base-station 120, i.e. located outside the terrestrial coverage area Ra and inside the extended coverage area Raa, and therefore experience interference between the non-terrestrial signals 302 and the terrestrial signals 102. In this case, the UEs 200 are only able to use half of the bandwidth, i.e., the first portion of the frequency F1 used by the terrestrial network 100a, since the non-terrestrial network 100b is using the second portion of the resource F2, T2, and UEs 200 within this area are biased to use the frequency associated with the terrestrial network 100a (as previously discussed). Therefore, this first method implies that from an operator perspective (the controller 130), UEs 200 within the terrestrial coverage area Ra fail to see a reduction in user experience, and UEs 200 outside this region (i.e., the terrestrial coverage area Ra) only use half of the bandwidth, i.e., F1/F2 or T1/T2 based on the location of the UE 200. In summary, the controller 130 reduces or trades-off the effective full bandwidth coverage area size to cover a much larger area with the non-terrestrial network 100b overlay (over the terrestrial network 100a). As can be seen in FIG. 1A, the non-terrestrial coverage area Rb is larger but has less bandwidth.

E-PDCCH Method

Another method used to protect the control channel 502 is E-PDCCH (enhanced physical downlink control channel), which is a feature defined in the 3GPP release 11. E-PDCCH provides an enhanced downlink control channel 502 to support increased control channel capacity, frequency domain ICIC, beam forming, and/or diversity. The use of E-PDCCH is only available for UEs 200 that support 3GPP release 11. In E-PDCCH, the information associated with the control channel 502 is carried on separate frequency resources (e.g., subcarrier or subband) along all the time blocks. That is, as opposed to the PDCCH (physical downlink control channel) where the control information is carried in the first few symbols (up to 3) of the time block, in E-DPCCH the information associated with the control channel 502 is carried across all the time blocks but limited to a few frequency resource blocks. To reduce the impact of interference between the terrestrial network 100a and the non-terrestrial network 100b, the satellite 300 and terrestrial eNB 120 could co-ordinate and agree to use different resource blocks in the frequency domain. Thus the control channel 502 of both the satellite 300 and terrestrial eNB 120 would be protected against interference.

eICIC Method

In some implementations, enhanced inter-cell interference coordination (eICIC) techniques are used between the terrestrial network 100a and the non-terrestrial network 100b to protect the control channel and ultimately mitigate the interference between the two networks 100a, 100b. In some examples, this method is implemented in addition to one or more of the aforementioned methods or as a standalone method. eICIC may be used to reduce interference between two or more networks, such as the terrestrial network 100a and the non-terrestrial network 100b. eICIC is an interference control technology defined in 3GPP release 10, and is an advanced version of ICIC previously defined in 3GPP release 8, evolved to support HetNet (Heterogeneous network) environments. Therefore, only UEs 200 supporting 3GPP release 10 can implement this interference mitigation method. As described in 3GPP, ICIC and eICIC are implemented using multiple terrestrial networks 100a. However, a similar implementation may be applied to a combination of terrestrial and non-terrestrial networks 100a, 100b. To prevent inter-cell or inter-network interference, ICIC allows cell-edge or network-edge UEs 200 in neighbor cells to use different frequency ranges. eICIC allows cell-edge or network-edge UEs 200 to use different time ranges (subframes) for the same purpose. For example, with eICIC, a macro cell and small cells that share a co-channel can use radio resources in different ranges (i.e., subframes). As applied to the network 100 in FIGS. 1A and 1B, the non-terrestrial network 100b and the terrestrial network 100a that share a co-channel use radio resources in different ranges (i.e., subframes). eICIC includes two main features: Almost Blank Subframe (ABS) technology and Cell Range Expansion (CRE) technology. ABS prevents cell-edge UEs 200 in terrestrial networks 100a from being interfered with by neighboring non-terrestrial networks 100b by having both networks still use the same radio resources, but in different time ranges (subframes). ABS includes only control channels and cell-specific reference signals, user data, and is transmitted with reduced power. When eICIC is used, the HAP 300 transmits ABS according to a semi-static pattern. During these subframes, UEs 200 at the edge, typically in the CRE region Raa of the terrestrial network 100a, can receive downlink information, both control and user data. The HAP 300 may inform the terrestrial base-station 120 about the ABS pattern. CRE, as explained above, expands the coverage of a terrestrial network 100a, so that more UEs 200 near the network edge can access the terrestrial network 100a. In addition, eICIC may coordinate the blanking of subframes in the time domain between the terrestrial network 100a and the non-terrestrial network 100b. For example an agreed upon coordinated schedule between the non-terrestrial network 100b and the terrestrial network could be chosen such that at pre-defined times, the non-terrestrial network 100b blanks its signal 302. All terrestrial networks 100a may use the blanked time period of the non-terrestrial network 100b to transmit terrestrial signals 102 without interference from signals 302 of the non-terrestrial network 100b. In some implementations, a number of blanked sub-frames are determined based on a need of the network 100a, 100b. Therefore, if a large number of non-terrestrial signals 302 are blanked, then the capacity of the non-terrestrial network 100b would decrease, while the capacity of the terrestrial network 100a continues as is or is increased.

Beam Forming

A second method for reducing the interference between the non-terrestrial network 100b and the terrestrial network 100a is for the HAP 300 associated with the non-terrestrial network 100b to selectively form a beam on a coverage area Rb that does not interfere with the coverage area Ra associated with the terrestrial network 100a. Beam-forming, also known as spatial filtering is a signal processing technique used in sensor arrays, such as the phased array antenna 312, for directional signal transmission or reception. The technique is achieved by combining elements in a phased array in such a way that signals at particular angles experience constructive interference, while others experience destructive interference. Beam-forming may be used at both the transmitting and receiving ends to achieve spatial selectivity. In other words, beam-forming allows the non-terrestrial network 100b to selectively determine areas or regions that receive its signals 302. Beam forming may be implemented in one of three ways: based on listening (for power or for other eNBs), based on maps (i.e., static planning), or in combination with CA (discussed above). Beam forming allows the antenna on the HAP 300 to form a beam having a shape on a coverage area and to try to minimize coverage of an area that already has terrestrial coverage, resulting in a reduced interference between the non-terrestrial area and the terrestrial coverage area within that region.

To determine the beam-form or shape that the HAP 300 can use to transmit its signals 302, the HAP 300 identifies coverage areas Ra associated with terrestrial networks 100a having a transmission power. The HAP 300 may identify its beam-form by listening or identifying areas having terrestrial power (i.e., power associated with terrestrial networks 100a) on the ground, by identifying one or more eNBs 120 transmitting/receiving signals and generating power. Another method of identifying or listening to areas having terrestrial power is to identify waveforms associated with terrestrial base-stations 120. In some examples, terrestrial base-stations 120 are associated with a specific waveform signal 102; therefore, the HAP 300 may be configured to look for and identify these waveform signals 102 associated with the base-stations 120. In some implementations, the controller 130 can count the number of base-stations 120 within a specific geographical region. In some examples, the controller 130 can decode an identifier ID associated with a base-station 120 in a particular beam (or geographic region, or sector) and based on the count or number of base-stations 120 in a particular frequency and beam, the controller 130 may decide on how much power control to use for the non-terrestrial signal 302. One method would be to use a look-up table that has an index including the number of base-stations 120 seen and as an output the amount of power used for each non-terrestrial signal 302. The extension would also decode more than just the identifier ID associated with a base-station 120, but to also decode or identify a bandwidth that each base-station 120 is using.

In other words, the HAP 300 can listen to or identify power associated with a terrestrial coverage area 100a based on directionality. For example, the HAP 300 can point its antenna system 310 to transmit signals 302 in different directions and listen to and identify eNBs 120 on the ground. By sweeping the antenna system 310 and thus a beam signal 302 from the air over different coverage areas, an accurate understanding of the location of interference on the ground may be determined. In some examples, the HAP 300 adjusts the beam size of the signal 302 to a narrower beam signal 302 or a wider beam signal 300, allowing the controller 130 to more accurately specify a location of the source transmitting signal 102 causing the interference and an amount or value of interference. In some examples, the controller 130 or HAP 300 identifies a number of eNBs 120 based on a signature waveform associated with each eNB 120.

In some implementations, beam-forming is achieved by identifying eNBs 120 based on an eNB map that includes all the eNBs within a region. In this case, the HAP 300 adjusts its antenna system 310 to form a beam excluding or avoiding areas that are covered by the identified map as being areas already covered by the terrestrial network 100a.

Another method mitigating the interference between terrestrial signals 102 and non-terrestrial signals is for the HAP 300 to use beam forming along with CA (explained above). Additionally or alternatively, beam forming may be implemented on a coverage area or the beam may be formed based on users. In some examples, the non-terrestrial network 100b implements CA, but uses a beam-forming mode to transmit on a resource F1 or T1 (i.e., the secondary carrier). That is, the non-terrestrial network 100b may use different transmission modes (TM) on each of the primary and secondary carriers. For example, for a non-terrestrial network 100b, the primary carrier (on resource F2 or T2) can be in any TM mode including the commonly used TM2/TM3/TM4 while the secondary carrier (on resource F1 or T1) is doing beam-forming via TM7 (antenna port 5) or TMs 8-10 (antenna ports 7-14). Table 1 shows exemplary downlink transmission modes in LTE release 12. Other transmission modes may be available as well.

TABLE 1

| Transmission | | | |
|---|---|---|---|
| Modes | Description | DCI | Comment |
| 1 | Single transmission antenna | 1/1A | Single antenna port |
| | | | Port 0 |
| 2 | Transmit | 1/1A | 2 or 4 antennas |
| | | | ports 0, 1 ( . . . 3) |
| 3 | Open loop spatial | 2A | 2 or 4 antennas |
| | multiplexing with cyclic delay | | ports 0, 1 ( . . . 3) |
| | diversity (CDD) | | |
| 4 | Closed loop spatial | 2 | 2 or 4 antennas |
| | multiplexing | | ports 0, 1 ( . . . 3) |
| 5 | Multi-user MIMO | 1D | 2 or 4 antennas |
| | | | ports 0, 1 ( . . . 3) |
| 6 | Closed loop spatial | 1B | 1 layer (rank 1), |
| | multiplexing using a single | | 2 or 4 antennas |
| | transmission layer | | ports 0, 1 ( . . . 3) |
| 7 | Beam-forming | 1 | single antenna port, port 5 |
| | | | (virtual antenna port, actual |
| | | | antenna configuration |
| | | | depends on implementation) |
| 8 | Dual-layer beam-forming | 2B | dual-layer transmission, |
| | | | antenna ports 7 and 8 |
| 9 | 8 layer transmission | 2C | Up to 8 layers, |
| | | | antenna ports 7-14 |
| 10 | 8 layer transmission | 2D | Up to 8 layers, |
| | | | antenna ports 7-14 |

The terrestrial network 100a implements CA and uses both resources F1 and F2 or T1 and T2. In this case, depending on how good the beam-forming is, UEs 200 inside the extended coverage area Raa fail to experience any interference and can utilize the full bandwidth via the terrestrial network 100a (but there may be a bias to use the terrestrial network 100a when the UE 200 is within the extended coverage region Raa). In other words, the HAP 300 projects a null towards the terrestrial base-station 120. More specifically, the HAP 300 fails to transmit signals 302 to the extended coverage region Raa (including the terrestrial coverage region Ra). The HAP is transmitting signals on F1, however, via careful user-based beam forming, none of these signals are going towards Raa or Ra. UEs 200 outside the extended coverage region Raa may also utilize the full bandwidth, since the non-terrestrial network 100b is utilizing CA and there is no interference with the terrestrial network 100a outside the extended coverage region Raa. In some examples, power on the eNB 120 is allocated depending on a need of the UE 200. Since we are using LTE beam forming to specific UE's (via TM7 for example) we can allocate the power to each individual UE depending on the need of that particular UE. This allows us to further reduce the interference to the terrestrial network.

As previously described, beam-forming uses multiple antennas to control the direction of a wave-front by appropriately weighting a magnitude and a phase of individual antenna signals (transmit beam-forming). Receive beam-forming determines the direction that a wave-front will arrive (direction of arrival or DoA). Adaptive beam-forming refers to a technique of continually applying beam-forming to a moving receiver. The controller 130 may compute beam-forming weights by at least two different approaches. A first approach allows the controller 130 to listen to the downlink transmission signals 102 of the terrestrial network 100a, which is particularly effective in TDD, due to channel reciprocity. The second approach allows the controller 130 to listen to the UE uplink transmissions (e.g., sounding reference signal (SRS), which is the uplink channel quality evaluation). In particular, the controller 130 may listen to UEs 200 connected to the non-terrestrial network 100b that are in the proximity of the terrestrial cell. The controller 130 may identify the UEs 200 to listen to, based on neighbor cell measurement reports, as an example, or location data as an another example. A third approach allows the controller 130 to listen to the UE uplink transmissions of UEs 200 connected to the terrestrial network 100a. This may entail some coordination with the base-station 120 to exchange the uplink parameters of its connected UEs 200.

Yet another method that may be used to mitigate the interference between terrestrial signals 102 and non-terrestrial signals is for the HAP 300 to use beam forming eICIC with beam-forming transmission in the non-terrestrial network 100b. The non-terrestrial network 100 (e.g., the HAP 300) exchanges information with the terrestrial network 100a on the ABS patterns. Non-terrestrial network 100b transmits with a beam-forming TM on the subframes it indicates as almost blanked to the terrestrial network 100a. The beam-forming may be performed using one of the methods described above, i.e., listening to the terrestrial cell signals or the UE signals in the proximity of the terrestrial cells. In this case, the terrestrial network 100a transmits on the entire time resources, i.e., using the entire bandwidth. The non-terrestrial network 100b (e.g., the controller 130 or the data processing device 320 of the HAP 300) may determine the ABS resources based on the number of terrestrial networks 100a, load on the terrestrial networks 100a, load on the non-terrestrial networks 100b, and locations of the terrestrial networks 100a (e.g., nullifying may only occur if the distribution of the terrestrial networks permit).

Power Control

Controlling the power of the transmission signal from the HAP 300 is yet another method to reduce interference between the terrestrial network 100a and the non-terrestrial network 100b. For example, the controller 130 may identify power (e.g., received power at the user device 202) associated with one or more base-stations 120 and their associated terrestrial network 100a. Once identified, the controller 130 communicates with the HAP 300, and in turn the HAP 300 adjusts (i.e., reduces) the power of its signals being transmitted to the terrestrial network 100a coverage region Ra, Raa.

The controller 130 or HAP 300 identifies coverage regions 100b associated with terrestrial networks 100a having a transmission power. The controller 130 or HAP 300 may identify regions having power from a terrestrial network 100a by listening or identifying areas having terrestrial power (i.e., power associated with terrestrial networks 100a) on the ground, by identifying one or more eNBs 120 transmitting/receiving signals and generating power. Another method for identifying regions that have power from a terrestrial network 100a is to identify waveforms associated with terrestrial base-stations 120. In some examples, terrestrial base-stations 120 are associated with a specific waveform signal 102; therefore, the HAP 300 (or the controller 130) may be configured to look for and identify these waveform signals 102 associated with the base-stations 120.

In other words, the HAP 300 (or the controller 130) can listen to or identify power associated with a terrestrial coverage area 100a based on directionality. For example, the HAP 300 can point its antenna system 310 to transmit signals 302 in different directions and listen to and identify eNBs 120 on the ground. By sweeping the antenna system 310 and thus a beam signal 302 from the air over different coverage areas, an accurate understanding of the location of interference on the ground may be determined. In some examples, the HAP 300 may adjust the beam size of the signal 302 to a narrower beam signal 302 or a wider beam signal 300, allowing the controller 130 to more accurately specify a location of the source transmitting signal 102 causing the interference and an amount or value of interference. In some examples, the controller 130 or HAP 300 identifies a number of eNBs 120 based on a signature waveform associated with each eNB 120.

In some implementations, power control may be achieved by identifying eNBs 120 based on an eNB map that includes all the eNBs 120 within a region. In this case, the HAP 300 adjusts the power of the transmitted signal 302. In some examples, the HAP 300 adjusts the power all its outputted signals 302, while in other examples, the HAP 300 adjusts the power of signals being transmitted to the terrestrial coverage area Ra, Raa (i.e., combination of power control and beam forming).

In some implementations, the controller 130 can count the number of base-stations 120 within a specific geographical region. In some examples, the controller 130 decodes an identifier ID associated with a base-station 120 in a particular beam (or geographic region, or sector) and based on the count or number of base-stations 120 in a particular frequency and beam, the controller 130 may decide on how much power control to use for the non-terrestrial signal 302. One method would be to use a look-up table, which has an index including the number of base-stations 120 seen and as an output the amount of power used for each non-terrestrial signal 302. The extension would also be decode more than just the identifier ID associated with a base-station 120, but to also decode or identify a bandwidth that each base-station 120 is using. In some implementations, if a portion of the frequency spectrum is used more than another portion of the frequency spectrum, then a portion of the frequency spectrum can have lower power than the frequency portion which has more use-age by terrestrial base-stations 120.

Carrier Aggregation and Power Control

In some implementations, the non-terrestrial network 100b implements CA, however, the power transmitted on the first resource portion F1, T1 (i.e., a secondary carrier) is lower than the power transmitted on the second resource portion F2, T2 (i.e., a primary carrier) (see FIG. 5B). In addition, the terrestrial network 100a also uses CA and uses both the first and second resource portions F1, F2, T1, T2. In this instance, most of the cases described with respect to the first method hold; however, UEs 200 outside the extended coverage region Raa are able to utilize the entire bandwidth due to the implementation of CA by the non-terrestrial network 100b. In addition, some UEs 200 inside the terrestrial coverage region Ra may not be able to utilize the entire bandwidth because of interference from the non-terrestrial network 100b. This effect of being unable to utilize the entire bandwidth is limited to UEs 200 that are at the edge of terrestrial coverage. The second method may be considered an optimization of the first method. The exact performance of the second method depends on determining the power of the transmission of the non-terrestrial signal 302 on the first portion of the resource F1, 1. The power may be determined based on semi-static parameters, such as a number of terrestrial networks 100a or regions Ra, a total load on the terrestrial networks 100a or regions Ra in comparison to the load on the non-terrestrial networks 100b or regions Rb, and a capacity associated with the CCH 502.

eICIC with Power Control

In some example, the use of eICIC with reduced power transmission in the non-terrestrial network 100b may be considered. The non-terrestrial network 100b and the terrestrial networks 100a exchange information on the ABS patterns. The non-terrestrial network 100b transmits with low power on the subframes it indicates as blanked to the terrestrial network 100a. The terrestrial network 100a transmits on the entire time resources.

The methods described above for reducing interference between the non-terrestrial network 100b and the terrestrial network 100a may be used as standalone methods, or one or more methods may be combined. For example, the controller 130 may implement eICIC and power control on the primary carrier F1, T1 while implementing beam-forming on the secondary carrier F2, T2. Other combinations are possible as well.

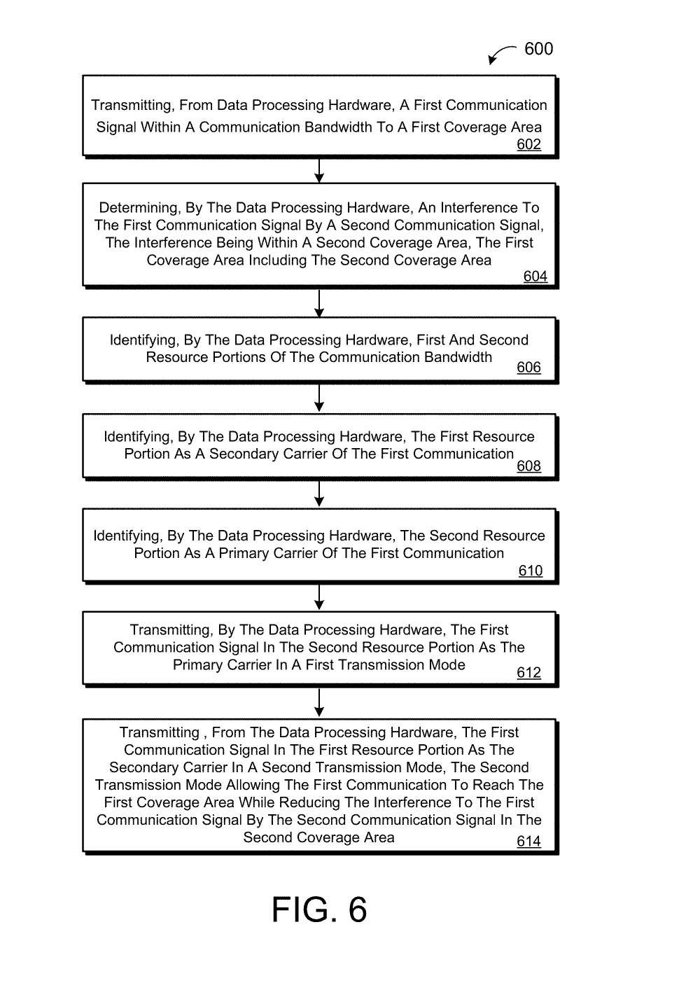

FIG. 6 illustrates a method 600 of communication using CA and beam-forming based on the system and network 100 described above and in FIGS. 1A-5B. The described method mitigates interference between signals 102, 302 transmitted from a terrestrial base-station 120 and a HAP 300, both reaching a UE 200. In addition, the HAP 200 implements both CA and beam-forming to transmit signals 302.

At block 602, the method 600 includes transmitting, from data processing hardware, a first communication signal 302 within a communication bandwidth B to a first coverage region Rb. In some examples, the data processing hardware is the controller 130 (having memory hardware 136) that is standalone or part of the terrestrial base-station 120, the UE 200, or the HAP 300.

At block 604, the method 600 includes determining, by the data processing hardware 130, an interference to the first communication signal 302 by a second communication signal 102, where the interference is within a second coverage area Ra, Raa. A dedicated signal/data processing hardware 130 (e.g., controller) may or may not be needed. In some examples, the controller 130 computes the expected interference levels via analysis and or simulation. The first coverage area Rb includes the second coverage area Ra, Raa. More specifically, the first coverage area Rb covers a larger geographical area than the second coverage area Rb, Rbb and includes/encompasses the second coverage area Rb, Rbb.

At block 606, the method 600 includes identifying, by the data processing hardware 130, first and second resource portions F1, F2, T1, T2 of the communication bandwidth B. A dedicated signal/data processing hardware 130 (e.g., controller) may or may not be needed. In some examples, the controller 130 computes the expected interference levels via analysis and or simulation. At block 608, the method 600 includes identifying, by the data processing hardware 130, the first resource portion F1, T1 as a secondary carrier of the first communication 302 (FIG. 5B). In addition, at block 610 the method 600 includes identifying, by the data processing hardware 130, the second resource portion F2, T2 as a primary carrier of the first communication 302.

At block 612, the method 600 includes transmitting the first communication signal 302 in the second resource portion F2, T2 as the primary carrier in a first transmission mode (e.g., TM2/TM3/TM4). At block 614, the method 600 includes transmitting the first communication signal 302 in the first resource portion F1, T1 as the secondary carrier in a second transmission mode (e.g., TM5, TM8-10). The second transmission mode (e.g., TM5, TM8-10) allows the first communication 302 to reach the first coverage area Rb while reducing the interference to the first communication signal 302 by the second communication signal 302 in the second coverage area Rb. In some examples, the first and second resource portions are frequency portions or time portions. Additionally or alternatively, the second coverage area may be within the first coverage area or the second coverage area may be partially within the first coverage area.

In some examples, the first transmission mode allows the first communication signal 302 to reach the first coverage area Rb and the second coverage area Ra, Raa. In some examples, the method 600 further includes causing a phased array antenna system 310 in communication with the data processing hardware 130 to transmit the first communication signal 302 in the first resource portion F1, T1 as the secondary carrier in the second transmission mode (e.g., TM5, TM8-10) to the first coverage area Rb while reducing the interference to the first communication signal 302 by the second communication signal 102 in the second coverage area. Ra, Raa. In some examples, the method 600 includes: identifying, by the data processing hardware 130, the first coverage area Rb; identifying, by the data processing hardware 130, the second coverage area Ra, Raa; identifying, by the data processing hardware 130, a transmission region that includes the first coverage area Rb while reducing impact to the second region Ra, Raa; and adjusting one or more antennas of an array of antennas 312 of the phased array antenna system 310 to transmit a beam configured to reach the transmission region (Rb but not Ra, Raa).

The method 600 may also include determining, by the data processing hardware 130, one or more beam-forming weights associated with the beam, by one of determining a downlink signal transmission of the second communication signal 102 and determining an uplink transmission of a user device configured to receive the first communication signal 302. In this case, the user device is within the second coverage area.

The phased array antenna system 310 may be disposed on one of an aircraft 300a, a communication balloon 300b, or a satellite 300c; and a terrestrial base-station 120 positioned on the earth transmits the second communication signal 102. A first power associated with the first communication signal 302 in the first frequency portion may be greater than a second power associated with the first communication signal 302 in the second frequency portion.

In some implementations, the method 600 includes executing, by the data processing hardware 130, enhanced inter-cell interference coordination (eICIC) techniques between the first and second communication signals 302, 102. The eICIC techniques are defined by 3GPP release 10. The method 600 may also include, when transmitting the first communication signal 302, executing, by the data processing hardware 130, cross-carrier-scheduling for scheduling data packets associated with the first communication signal 302. Each data packet may include data channels 504 and a control channel 502. In some examples, the data channels 504 are configured to be transmitted on the first and second frequency portions F1, F2, and the control channel 502 is configured to be transmitted on only the second resource portion F2, T2. In other examples, the data channels 504 are configured to be transmitted on the first and second frequency portions F1, F2, and the control channel 502 is configured to be transmitted on only the first resource portion F1, T1. In some examples, the method further includes executing enhanced physical downlink control channel (E-PDCCH) techniques between the first and second communication signals, the E-PDCCH techniques defined by 3GPP release 11.

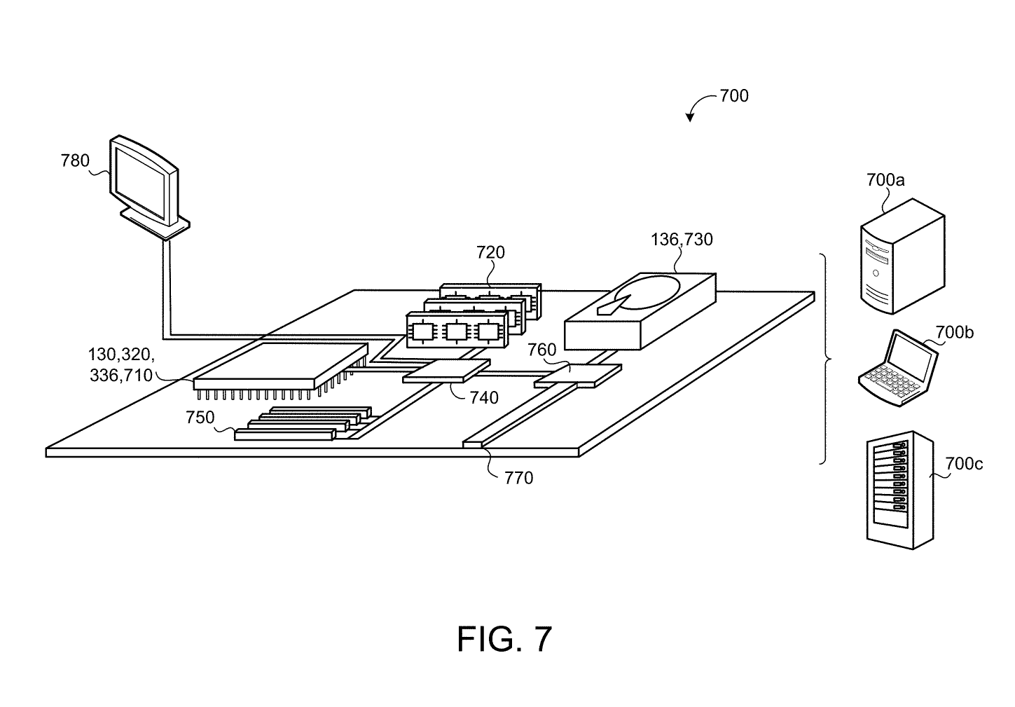

FIG. 7 is schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the disclosure described and/or claimed in this document.

The computing device 700 includes a processor 130, 320, 336, 710, memory 720, memory hardware or a storage device 136, 730, a high-speed interface/controller 740 connecting to the memory 720 and high-speed expansion ports 750, and a low speed interface/controller 760 connecting to low speed bus 770 and storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and low-speed expansion port 770. The low-speed expansion port 770, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A communication system comprising:
an antenna system configured to:
transmit communication signals to a coverage area;
execute beam forming to adjust transmission of the communication signals to modify the coverage area; and
adjust a power of the communication signal;
data processing hardware in communication with the antenna system; and
memory hardware in communication with the data processing hardware and the antenna system, the memory hardware storing instructions that when executed on the data processing hardware cause the data processing hardware to perform operations comprising:
transmitting a first communication signal from the antenna system within a communication bandwidth to a first coverage area, the communication bandwidth having first and second resource portions comprising frequency portions or time portions;
determining an interference to the first communication signal by a second communication signal; and
reducing the interference to the first communication signal by a second communication signal by at least one of:
adjusting the first coverage area by adjusting the transmission of the first communication signal within one of the first and second resource portions of the communication bandwidth; or
adjusting a power of the first signal by adjusting the transmission of the first communication signal within one of the first and second resource portions of the communication bandwidth.

2. The communication system of claim 1, wherein adjusting the first coverage area comprises:
identifying a second coverage area associated with a power of the second signal;
transmitting the first communication signal to the first coverage area while reducing interference to the second coverage area.

3. The communication system of claim 1, wherein adjusting the first coverage area comprises:
identifying a second coverage area receiving a transmission from a base-station transmitting the second communication signal; and
transmitting the first communication signal to the first coverage area while reducing interference to the second coverage area.

4. The communication system of claim 1, wherein adjusting the first coverage area comprises:
identifying a second coverage area using a map stored on the memory hardware, the second coverage area including a source transmitting the second communication; and
transmitting the first communication signal to the first coverage area while reducing interference transmission to the second coverage area.

5. The communication system of claim 1, wherein adjusting the power of the first signal comprises:
identifying a power of the second signal;
identifying a second coverage area associated with the power of the second signal;
reducing the power of the first signal, the power of the first signal being less than the power of the second signal; and
transmitting the first communication signal having the reduced power to the first and second coverage area.

6. The communication system of claim 1, wherein adjusting the power of the first signal comprises:
identifying a base-station transmitting the second communication signal;
identifying a second coverage area receiving a transmission from the base-station;
reducing the power of the first signal, the power of the first signal being less than the power of the second signal; and
transmitting the first communication signal having the reduced power to the first and second coverage area.

7. The communication system of claim 1, wherein adjusting the power of the first signal comprises:
identifying a second coverage area using a map stored on the memory hardware, the second coverage area identifying a source of the second communication;
reducing the power of the first signal, the power of the first signal being less than the power of the second signal; and
transmitting the first communication signal having the reduced power to the first and second coverage area.

8. A communication system comprising:
data processing hardware; and
memory hardware in communication with the data processing hardware, the memory hardware storing instructions that when executed on the data processing hardware cause the data processing hardware to perform operations comprising:
transmitting a first communication signal within a communication bandwidth to a first coverage area;
determining an interference to the first communication signal by a second communication signal, the interference being within a second coverage area, the first coverage area including the second coverage area;
identifying first and second resource portions of the communication bandwidth;
transmitting the first communication signal in the second resource portion in a first transmission mode; and
transmitting the first communication signal in the first resource portion in a second transmission mode, the second transmission mode allowing the first communication to reach the first coverage area while reducing the interference to the first communication signal by the second communication signal in the second coverage area.

9. The communication system of claim 8, wherein the first and second resource portions are frequency portions or time portions.

10. The communication system of claim 8, further comprising:
identifying the first resource portion as a secondary carrier of the first communication;
identifying the second resource portion as a primary carrier of the first communication;
transmitting the first communication signal in the second resource portion as the primary carrier in the first transmission mode; and
transmitting the first communication signal in the first resource portion as the secondary carrier in the second transmission mode.

11. The communication system of claim 10, further comprising an antenna system in communication with the data processing hardware, wherein transmitting the first communication signal in the first resource portion as the secondary carrier in the second transmission mode comprises causing the antenna system to transmit the first communication signal in the first resource portion as the secondary carrier in the second transmission mode to the first coverage area while reducing the interference to the first communication signal by the second communication signal in the second coverage area.

12. The communication system of claim 11, wherein the antenna system comprises an array of antennas and the operations further comprise:
identifying the first coverage area;
identifying the second coverage area;
identifying a transmission region that includes the first coverage area while reducing the interference to the first communication signal by the second communication signal in the second coverage area; and
adjusting one or more antennas to transmit a beam configured to reach the transmission region.

13. The communication system of claim 12, wherein the operations further comprise determining one or more beam-forming weights associated with the beam, by one of:
receiving a downlink signal transmission of the second communication signal; and
receiving an uplink transmission of a user device configured to receive the first communication signal, the user device being near or within the second coverage area.

14. The communication system of claim 11, wherein the antenna system is positioned on one of an aircraft, a communication balloon, or a satellite, and wherein a terrestrial base-station positioned on the earth is transmitting the second communication signal.

15. The communication system of claim 11, wherein the antenna system comprises a phased array antenna.

16. The communication system of claim 8, wherein the second coverage area is within the first coverage area or the second coverage area is partially within the first coverage area.

17. The communication system of claim 8, wherein the first transmission mode allows the first communication signal to reach the first coverage area and the second coverage area.

18. The communication system of claim 8, wherein a first power associated with the first communication signal in the first resource portion is greater than a second power associated with the first communication signal in the second resource portion.

19. The communication system of claim 8, wherein the operations further comprise: executing enhanced inter-cell interference coordination (eICIC) techniques between the first and second communication signals, the eICIC techniques defined by 3GPP release 10.

20. The communication system of claim 19, wherein the first resource portion is a first set of subframes and the second resource portion is a second set of subframes.

21. The communication system of claim 8, wherein the operations further comprise, when transmitting the first communication signal, executing cross-carrier-scheduling for scheduling data packets associated with the first communication signal, each data packet including data channels and a control channel, wherein the data channels are configured to be transmitted on the first and second resource portions, and the control channel is configured to be transmitted on only the second resource portion.

22. The communication system of claim 8, wherein the operations further comprise, when transmitting the second communication signal, executing cross-carrier-scheduling for scheduling data packets associated with the second communication signal, each data packet including data channels and a control channel, wherein the data channels are configured to be transmitted on the first and second resource portions, and the control channel is configured to be transmitted on only the first resource portion.

23. The communication system of claim 8, wherein the operations further comprise executing enhanced physical downlink control channel (E-PDCCH) techniques between the first and second communication signals, the E-PDCCH techniques defined by 3GPP release 11.

24. The communication system of claim 23, wherein the first resource portion is a first set of subcarriers and the second resource portion is a second set of subcarriers.

25. A method comprising:
transmitting, from data processing hardware, a first communication signal within a communication bandwidth to a first coverage area;
determining, by the data processing hardware, an interference to the first communication signal by a second communication signal, the interference being within a second coverage area, the first coverage area including or partially including the second coverage area;
identifying, by the data processing hardware, first and second resource portions of the communication bandwidth;
transmitting, by the data processing hardware, the first communication signal in the second resource portion in a first transmission mode; and
transmitting, from the data processing hardware, the first communication signal in the first resource portion in a second transmission mode, the second transmission mode allowing the first communication to reach the first coverage area while reducing the interference to the first communication signal by the second communication signal in the second coverage area.

26. The method of claim 25, wherein the first and second resource portions are frequency portions or time portions.

27. The method of claim 25, further comprising: identifying, by the data processing hardware, the first resource portion as a secondary carrier of the first communication;
identifying, by the data processing hardware, the second resource portion as a primary carrier of the first communication;
transmitting, by the data processing hardware, the first communication signal in the second resource portion as the primary carrier in the first transmission mode; and
transmitting, from the data processing hardware, the first communication signal in the first resource portion as the secondary carrier in the second transmission mode.

28. The method of claim 27, further comprising causing a phased array antenna system in communication with the data processing hardware, to transmit the first communication signal in the first resource portion as the secondary carrier in the second transmission mode to the first coverage area while reducing the interference to the first communication signal by the second communication signal in the second coverage area.

29. The method of claim 28, further comprising:
identifying, by the data processing hardware, the first coverage area;
identifying, by the data processing hardware, the second coverage area;
identifying, by the data processing hardware, a transmission region that includes the first coverage area while reducing the interference to the first communication signal by the second communication signal in the second coverage area; and
adjusting one or more antennas of an array of antennas of the phased array antenna system to transmit a beam configured to reach the transmission region.

30. The method of claim 29, further comprising determining, by the data processing hardware, one or more beam-forming weights associated with the beam, by one of:
receiving a downlink signal transmission of the second communication signal; and
receiving an uplink transmission of a user device configured to receive the first communication signal, the user device being near or within the second coverage area.

31. The method of claim 29, wherein the phased array antenna system is positioned on one of an aircraft, a communication balloon, or a satellite, and wherein a terrestrial base-station positioned on the earth is transmitting the second communication signal.

32. The method of claim 31, wherein a first power associated with the first communication signal in the first resource portion is greater than a second power associated with the first communication signal in the second resource portion.

33. The method of claim 25, wherein the second coverage area is within the first coverage area or the second coverage area is partially within the first coverage area.

34. The method of claim 25, wherein the first transmission mode allows the first communication signal to reach the first coverage area and the second coverage area.

35. The method of claim 25, further comprising executing, by the data processing hardware, enhanced inter-cell interference coordination (eICIC) techniques between the first and second communication signals, the eICIC techniques defined by 3GPP release 10.

36. The method of claim 25, further comprising, when transmitting the first communication signal, executing, by the data processing hardware, cross-carrier-scheduling for scheduling data packets associated with the first communication signal, each data packet including data channels and a control channel, wherein the data channels are configured to be transmitted on the first and second resource portions, and the control channel is configured to be transmitted on only the second resource portion.

37. The method of claim 25, further comprising, when transmitting the second communication signal, executing, by the data processing hardware, cross-carrier-scheduling for scheduling data packets associated with the second communication signal, each data packet including data channels and a control channel, wherein the data channels are configured to be transmitted on the first and second resource portions, and the control channel is configured to be transmitted on only the first resource portion.

38. The method of claim 25, further comprising executing, by the data processing hardware, enhanced physical downlink control channel (E-PDCCH) techniques between the first and second communication signals, the E-PDCCH techniques defined by 3GPP release 11.
